(19) United States
(12) Patent Application Publication
(10) Pub. No.: US 2006/0089014 A1
(43) Pub. Date: Apr. 27, 2006

(54) Module connector

(75) Inventor: Chao-Chang Li, Tu-Chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/154,195

(22) Filed: Jun. 15, 2005

(30) Foreign Application Priority Data
Oct. 25, 2004 (CN) 2200420080597.7

(51) Int. Cl. H01R 12/00

(52) U.S. Cl. 439/68

(57) ABSTRACT

A module connector comprises an insulating housing defining a chamber for accommodating the module body; a plurality of contacts received in the insulating housing comprising a plurality of contacting portions exposed in the chamber of the housing for electrically connecting with the module body; and a holding member being assembled onto the housing after the module body accommodated in the chamber of the housing and provided with a restricting portion for preventing the module body from loosing.

### BACKGROUND OF THE INVENTION

1. Field of the invention

The present invention relates to a module connector to which a module body such as a memory module or a camera module is firmly fitted.

2. Description of Related Art

With development of cellular mobile phones or the likes, a lot of additional functions such as taking pictures etc. are added to the mobile phones or the likes. In order to achieve functions such as taking pictures etc., camera modules are furnished to the mobile phones or the likes in virtue of module connectors.

US Pat. Pub. No. 2004/0068868 disclosures a module connector to which a camera module can be fitted. The modular connector defines a chamber for accommodating the camera module and comprises a plurality of contacts disposed on side walls of the chamber. The camera module is provided with a plurality of electrical pads arranged on an outer periphery thereof corresponding to the contacts of the module connector. When assembled, the camera module is directly inserted into the chamber of the module connector to achieve electrical connection between the electrical pads thereof and the contacts of the module connector.

However, because the camera module is directly received into the chamber of the module connector without help of additional holding appliance, the pads of camera module and contacts of the module connector are not firmly connected with each other when encountering vibration, thus affecting signal transmission.

Hence, an improved module connector is required to overcome the disadvantages of the prior art.

### SUMMARY OF THE INVENTION

An object of the present invention is to provide a module connector which can make a module body to be firmly secured therein.

Accordingly, to achieve above-mentioned object, a module connector to which a module body is electrically connected comprises an insulating housing defining a chamber for accommodating the module body; a plurality of contacts received in the insulating housing comprising a plurality of contacting portions exposed in the chamber of the housing for electrically connecting with the module body; and a holding member being assembled onto the housing after the module body accommodated in the chamber of the housing and provided with a restricting portion for preventing the module body from loosing.

The detailed features of the present invention will be apparent in the detailed description with appropriate reference to the accompanying drawings.

### BRIEF DESCRIPTION OF THE DRAWINGS

FIG. 1 is an assembled perspective view of the module connector in accordance with the present invention in which a camera module is accommodated;

FIG. 2 is an assembled perspective view of the module connector shown in FIG. 1, but from another aspect;

FIG. 3 is an assembled perspective view of the module connector shown in FIG. 1, but a holding member not assembled;

FIG. 4 is an exploded perspective view of the module connector shown in FIG. 1; and

FIG. 5 is an exploded perspective view of the module connector shown in FIG. 1, but from another aspect;

### DETAILED DESCRIPTION OF THE INVENTION

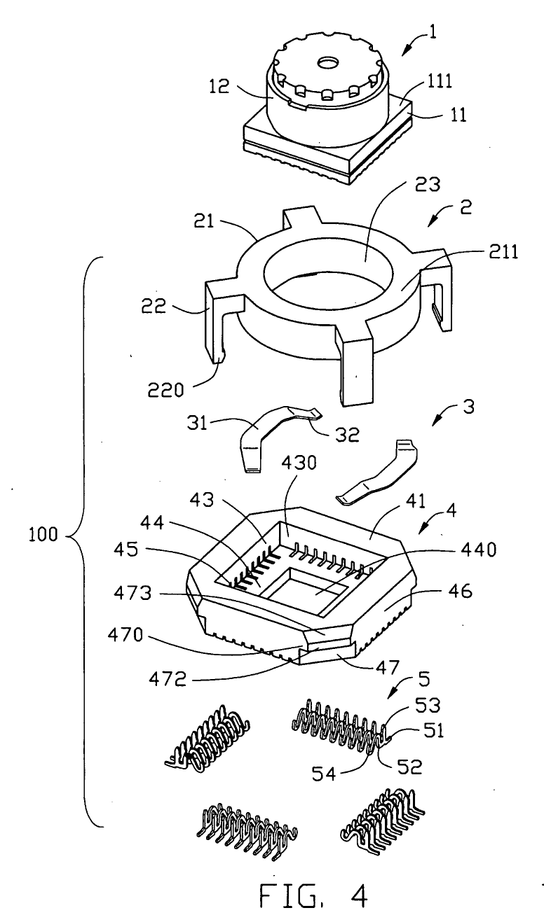

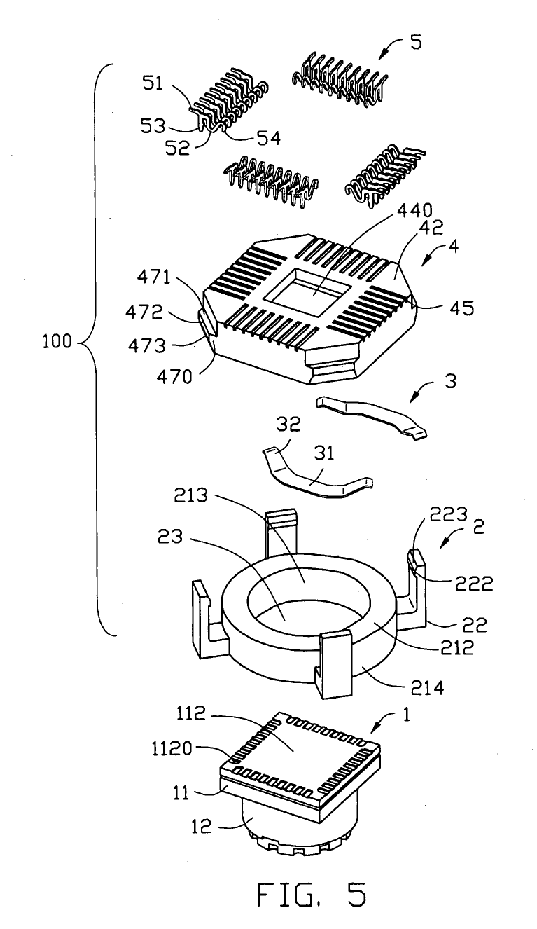

Referring to FIGS. 4 and 5, the module connector 100 in accordance with the present invention is adapted for electrically connecting a module body such as a camera module 1 with a wiring board (not shown).

The module connector 100 comprises an insulating housing 4, a plurality of contacts 5 received in the housing 4, a holding member 2 and a pair of resilient mats 3 located between the holding member 2 and the housing 4.

The insulating housing 4 is approximately a square box-like body having an upwardly-open chamber 430 for accommodating the camera module 1. The housing 4 has a top face 41, a bottom face 42, side walls 46 and corners 47 arranged between adjacent two side walls 46 and the housing 4 further comprises inner side walls 43, an inner bottom face 44 and a through hole 440 is formed in middle of the bottom wall 44 and through it downwardly for dispersing heat, and the housing 4 is provided with a plurality of receiving passages 45 for receiving contacts 5. The passages 45 are formed at connections between the inner side walls 43 and the inner bottom face 44 and are extending downwardly through the bottom face 42.

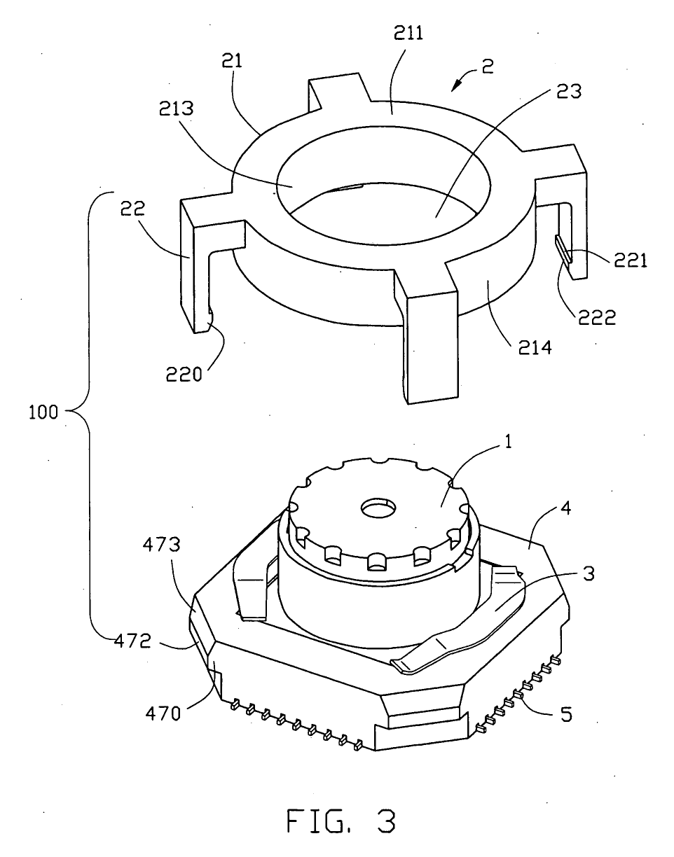

Referring to FIGS. 3 and 4, the contacts 5 are received in the passages 45 of the housing 4. Each of the contacts 5 comprises a soldering portion 51 exposed out of the bottom face 42 of the housing 4 for soldering on the wiring board (not shown), a bending portion 53 and a holding portion 53 and a contacting portion 54 exposed in the chamber 430. The bending portion 53 and the holding portion 53 are in the passages 45.

Referring to FIGS. 4 and 5, the camera module 1 is accommodated in the chamber 430 of the housing 4 (shown in FIG. 3) and comprises a module body 11 served as a lower portion. The module body 11 is formed with an upper face 111 and a bottom face 112. A plurality of contact pads 1120 corresponding to the contacting portions 54 of the contacts 5 are formed on the bottom face 112 for electrically connected with the contacting portions 54 and a lens portion 12 served as an upper portion formed on the upper face 111 of the module body 11.

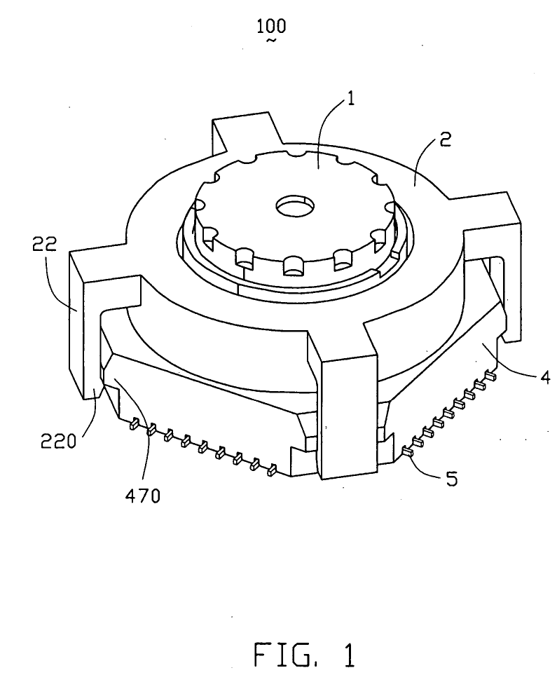

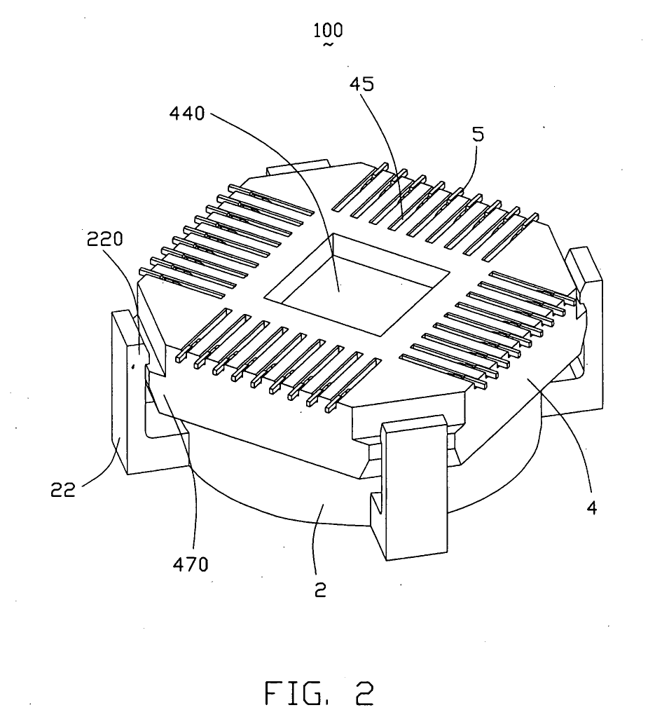

Referring to FIGS. 1 to 5, each of the corners 47 of the housing 4 is formed with an engaging portion 470 protruded outwardly from upper half portion thereof adjacent to the top face 41 of the housing 4. The engaging portion 470 comprises a locking face 471, a vertical face 472 and a slanting face 473. The holding member 2 is provided with a column body portion 21 served as a restricting portion and holding portions 22 corresponding to the engaging portions 470 of the housing 4. The column body portion 21 comprises a top face 211, a bottom face 212, a side face 214, a through hole 23 extending through the top face 211 and the bottom face 212 and an inner face 213. The holding portions 22 protrude outwardly from the column body portion 21 and are bent into a generally inverted L-shaped. Each of ends of the holding portions 22 has a locking portion 220 comprising a mating face 221 for locking with the locking face 471 of the housing 4, a vertical face 222 and a slanting face 223.

Referring to FIGS. 1 to 3, when assembled, the camera module 1 is received in the chamber 430 of the housing 4 with the upper face 111 of the camera module land the top face 41 of the housing 4 being approximately in same level. The pair of resilient mats 3 set on the upper face 111 and the top face 41 comprises base bodies 31 and resilient portions 32 and are arranged opposite to each other, then the holding member 2 is assembled with the lens portion 12 of the camera module 1 passed through the through hole 23 thereof. The mating face 221 of the holding member 2 is locked with the corresponding locking face 471 of the engaging portion 470 of the housing 4 to secure the holding member 2 on the housing 4 firmly, thus the holding member 2 presses downwardly the resilient mats 3 and then press the camera module 1 via the resilient mats 3 to make the camera module 1 plenarily accommodated in the chamber 430 of the housing 4, and the contact pads 120 of the camera module 1 to be electrically with the contacts 5 firmly. The resilient mats 3 are located between the holding member 2 and the housing 4 to not only press the camera module 1 but also serve as buffers.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A module connector, to which a module body is electrically connected, comprising:
an insulating housing defining a chamber for accommodating the module body;
a plurality of contacts received in the insulating housing comprising a plurality of contacting portions exposed in the chamber of the housing for electrically connecting with the module body; and
a holding member being assembled onto the housing after the module body accommodated in the chamber of the housing and provided with a restricting portion for preventing the module body from loosing and the module body being a camera module.

2. The module connector as described in claim 1, wherein the restricting portion is in a circular ring configuration.

3. The module connector as described in claim 2, wherein the restricting portion defines a through hole, through which an upper portion of the module body passes and the restricting portion presses a lower portion of the module body to make the module body accommodate in the chamber of the housing.

4. The module connector as described in claim 1, wherein the holding member is formed with a holding portion for latching on the housing.

5. The module connector as described in claim 4, wherein the housing is provided with an engaging portion formed on corners of adjacent two side walls thereof and the holding portion is engaged with the engaging portion to secure the holding member on the housing.

6. The module connector as described in claim 1, wherein further comprising at least a resilient mat located between the holding member and the housing, and the holding member presses the module body via the resilient mat to make the module body accommodate in the chamber of the housing.

7. A module connector assembly comprising:
an insulating housing having side walls defining a chamber therein;
a plurality of contacts received in the insulating housing, each of said contacts comprising a contacting portion exposed in the chamber of the housing;
a module body received in the chamber and electrically connected to the contacts; and
a holding member being assembled onto the housing after the module body accommodated in the chamber of the housing and provided with a restricting portion for preventing the module body from loosing; wherein
the holding member includes an opening through which an upstanding portion of the module body upwardly extends

8. The assembly as claimed in claim 7, wherein said holding member is vertically assembled to the housing.

9. The assembly as claimed in claim 7, wherein a resilient piece for vibration absorbing is sandwiched between the restriction portion and the module body, and said resilient piece is located beside the upstanding portion.

10. The assembly as claimed in claim 7, wherein said holding member is completely detached from the housing during assembling/disassembling the module body with regard to the housing.

11. The assembly as claimed in claim 7, wherein said restricting portion is of a ring-like configuration.

12. The assembly as claimed in claim 7, wherein said upstanding portion is a tens portion.

13. A module connector assembly comprising:
an insulating housing having side walls defining a chamber therein;
a plurality of contacts received in the insulating housing, said contacts comprising respectively a plurality of contacting portions exposed in the chamber of the housing;
a module body received in the chamber and electrically connected to the contacts; and
a holding member being assembled onto the housing after the module body accommodated in the chamber of the housing and provided with a restricting portion for preventing the module body from loosing; wherein
the holding member includes an opening so as to allow the module body to vertically communicate with an exterior, and a resilient piece located between the holding member and the module body and pressed by the holding member to impose a force upon said module body.

14. The assembly as claimed in claim 13, wherein said resilient piece is discrete from the holding member.

15. The assembly as claimed in claim 13, wherein said holding member is completely removed from the housing during assembling/disassembling the module body with regard to the housing.

16. The module connector as claimed in claim 1, further including a resilient piece downwardly pressed by the holding member thereby to downwardly press against the module body.

17. The assembly as claimed in claim 7, further including a resilient piece downwardly pressed by the holding member thereby to downwardly press against the module body.

18. The module connector assembly as claimed in claim 13, wherein said resilient piece is downwardly pressed by the holding member thereby to downwardly press against the module body.
